(19) United States
(12) Patent Application Publication
(10) Pub. No.: US 2007/0103914 A1
(43) Pub. Date: May 10, 2007

(54) LED replacement bulb

(75) Inventor: Michael G. McCaffrey, Windsor, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/269,501

(22) Filed: Nov. 8, 2005

(51) Int. Cl. F21S 13/10

(52) U.S. Cl. 362/363

(57) ABSTRACT

A replacement light bulb assembly for use in an incandescent light fixture utilizes a light emitting diode (LED). An LED is bonded to a base that fits within a typical incandescent light bulb fixture. The LED is electrically connected to the base and a center post within the base to form an electrical circuit when assembled within an incandescent light fixture. A control is connected to the LED to modify the LED output. The control can also be used to modify the voltage or current requirements of the light bulb assembly for use with DC current or AC current applications. An external shield or lens, or an internal shield or lens, may be added to the light bulb assembly or directly to the LED to alter the light emitted. Several variations of the light bulb assembly having each having base corresponding to a typical incandescent light bulb fixture may be available.

### BACKGROUND OF THE INVENTION

This invention is a replacement light for an incandescent light fixture where the replacement light uses a light emitting diode.

Common products such as flashlights, toys, instrument panels, etc. use incandescent light bulbs for providing light. However, incandescent light bulbs have the disadvantage of giving off heat when operating. The incandescent light bulbs thus use extra energy by converting the energy to lost heat. Incandescent light bulbs are also susceptible to damage by shaking or impact with the bulb. Damage caused by impact and shaking often causes the need to replace the incandescent light bulb. In addition, incandescent light bulbs have short life spans causing the need for frequent replacements.

Because use of incandescent light bulbs is so prevalent any replacement must be able to fit and operate with an incandescent light bulb fixture.

A replacement bulb for an incandescent light fixture which has increased life span and durability without converting energy to heat is needed.

### SUMMARY OF THE INVENTION

A replacement light bulb assembly for use in an incandescent light fixture utilizes a light emitting diode.

The replacement light bulb assembly includes a base and a light emitting diode (LED). The base fits within a typical incandescent light bulb fixture. The LED is bonded to the base with a non-conducting material and is electrically connected to the base through a base connector. A center post is located generally along the center of the base and is electrically connected to the LED to complete an electrical circuit when the light bulb assembly is placed within an incandescent light bulb fixture. The base has a non-conductive filler to electrically isolate the center post from the base.

A control is connected to the LED to modify the LED output to change the light intensity, duration (such as a flashing light), or color. The control can also be used to modify the voltage or current requirements of the light bulb assembly and allow use with both DC current and AC current. An external shield or lens, or an internal shield or lens, may be added to the light bulb assembly or directly to the LED to alter the light emitted from the light bulb assembly.

The replacement light bulb assembly fits within a typical incandescent light bulb fixture. Incandescent light bulbs have standard base sizing for common voltage and current ratings of the applications. Several variations of the replacement light bulb assembly each having a base corresponding to a typical incandescent light bulb fixture may be available.

These and other features of the present invention can be best understood from the following specification and drawings, the following of which is a brief description.

### BRIEF DESCRIPTION OF THE DRAWINGS

FIG. 1 is an illustration of an embodiment of a light bulb assembly of the present invention.

FIG. 2 is a cross-section of an embodiment of the light bulb assembly of the present invention.

FIG. 3 is an embodiment of the light bulb assembly of the present invention for use in a flashlight.

FIG. 4 is an embodiment of the light bulb assembly of the present invention for use in a night-light.

FIG. 5 is an embodiment of the light bulb assembly of the present invention for use in an automotive instrument panel.

### DETAILED DESCRIPTION OF THE PREFERRED EMBODIMENT

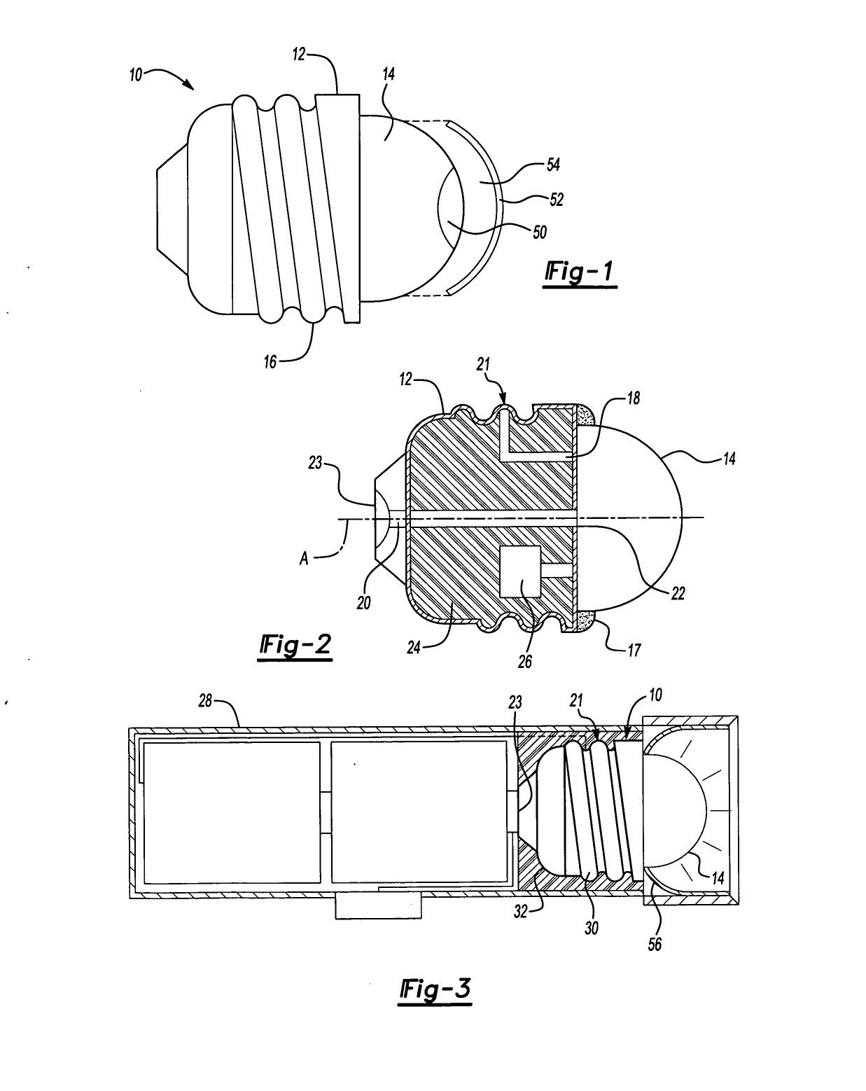

FIG. 1 shows an illustration of a light bulb assembly 10 of the present invention. The assembly includes a base 12 and a light emitting diode (LED) 14. The LED 14 is electrically connected to the base 12. The base 12 fits within a typical incandescent light bulb fixture. In the embodiment shown, the base 12 is a screw base and includes threads 16, which correspond to threads in the typical incandescent light bulb fixture, for retention. The bulb may include an internal shield or lens 50, which modifies the light characteristics of the LED 14. The light bulb assembly 10 may also include an external shield or lens 52 that is bonded to the light bulb assembly 10 or directly to the LED 14 with a bonding agent 54. The internal shield 50, external shield 52 and the bonding agent 54 may be translucent or opaque, and may possess optical characteristics, such as, but not limited to, altering the light in ranges outside the human visible spectrum.

FIG. 2 is a cross-section of the light bulb assembly of the present invention. The LED 14 is mounted onto the base 12. As shown, the LED 14 is bonded to the base 12 with a non-conducting material 17. The LED 14 may be mounted or retained on the base 12 by any known means that provide an electrically isolated mounting. The LED 14 is electrically connected to the base 12 through a base connector 18. The base connector 18 is connected to the LED 14 at one end and a screw contact 21 at the other.

Located within the base 12 is a center post 20. The center post 20 extends generally parallel to an axis A of the base 12 and leads to a base contact 23 of the base 12. The center post 20 is electrically connected to the LED 14 at the post connector location 22. The base 12 is filled with a non-conductive filler 24 to electrically isolate the center post 20 from the base 12. When the light bulb assembly 10 is assembled into an incandescent light fixture, an electric circuit to the LED 14 is completed through the screw contact 21 and the base contact 23.

A control 26 is connected to the LED 14 to modify the LED 14 output as desired. The control 26 is preferably positioned within the base 12 but may be located in any position convenient to the light bulb assembly 10 where the control 26 can be connected to the LED 14. The control 26 may be set at the time of manufacture of the light bulb assembly 10 to modify the LED 14 output as is known in the art. The control 26 may modify the light bulb assembly 10 output to change the light intensity, duration (such as a flashing light), or color. The control 26 can also be used to modify the voltage or current requirements of the light bulb assembly 10 for use with DC current of AC current applications. During manufacture the control 26 can be set allowing the light bulb assembly 10 to operate in most popular DC current voltage ratings such as 1.5V, 3V, 4.5V, 6V, 9V and 12V. The light bulb assembly 10 may also have typical household ratings of 110VAC and 220VAC. The control 26 may be set to modify the light bulb assembly 10 to other DC current or AC current settings as well. The LED may also be shielded to reduce direct viewing or to modify the direction of the light. Multiple LEDs may be used to increase the light intensity, color, duration (such as flashing), direction and time dependant characteristics when used with control 26.

As mentioned above, the light bulb assembly 10 fits within a typical incandescent light bulb fixture. Incandescent light bulbs have standard base sizing for common voltage and current ratings of the applications. Several variations of the light bulb assembly 10 each having the base 12, which corresponds to a typical incandescent light bulb fixture, may be available. For example, FIG. 3 is an illustration of one embodiment of the light bulb assembly 10 of the present invention in a flashlight 28. The base 30 is sized to a typical incandescent light bulb base for use in flashlights and corresponds in size to the flashlight bulb fixture 32. The control 26 (shown in FIG. 2) modifies the LED 14 to have typical output for use in a flashlight, a high intensity, white light, and a DC 3V setting. The LED 14 can be modified to change the directional nature of the emitted light. Shielding of the LED 14, either with an internal shield 50 or an external shield 52 bonded to the light bulb assembly 10 (as shown in FIG. 1), can be used to change the color, direction, dispersion, focus, prevent excessive direct exposure, introduce patterns to be projected, or adjust the light pattern to match the intended devices internal reflective geometry 56.

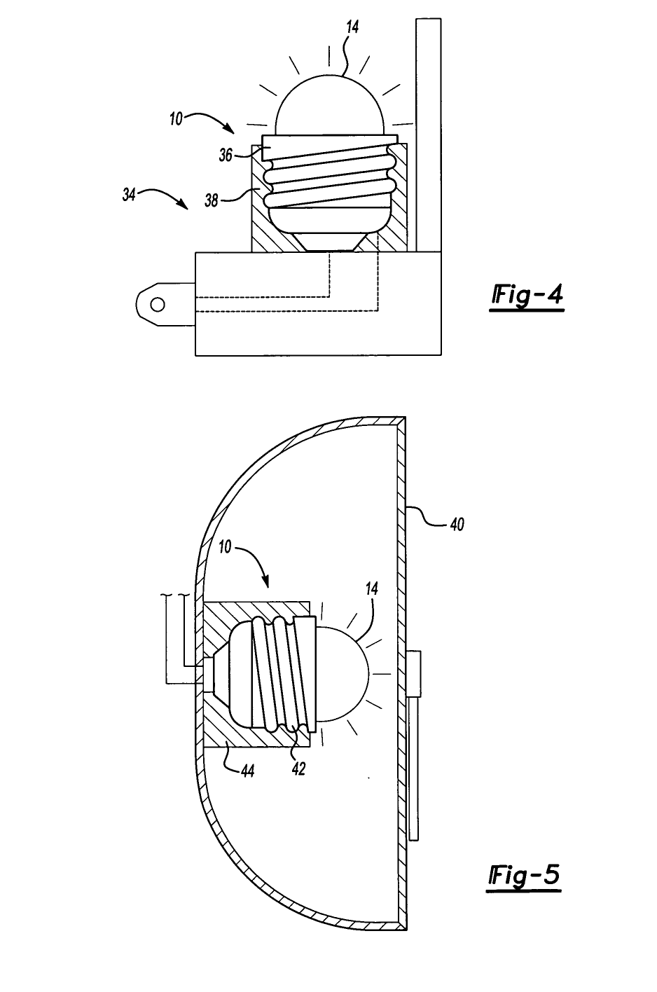

FIG. 4 is an illustration of another embodiment of the light bulb assembly 10 in a night-light 34. The base 36 is sized to a typical incandescent light bulb base 38 for use in night-lights. The control 26 (shown in FIG. 2) modifies the LED 14 to have typical night-light output of a low intensity, yellow light, and an AC 4 W or 7 W rating.

FIG. 5 is an illustration of another embodiment of the light bulb assembly 10 in an automotive instrument panel 40. A section of an instrument panel 40 is shown. The base 42 is sized to a typical incandescent light bulb base 44 for use with the instrument panel 40. The control 26 (shown in FIG. 2) modifies the LED 14 to have typical instrument panel 40 output of a low intensity, white light, and a DC 12V setting. Alternate embodiments of the light bulb assembly 10 with the control 26 set to modify the LED 14 output to other typical night-light 33, flashlight 28 or instrument panel 40 outputs may be utilized.

Although a preferred embodiment of this invention has been disclosed, a worker of ordinary skill in this art would recognize that certain modifications would come within the scope of this invention. For that reason, the following claims should be studied to determine the true scope and content of this invention.

1. A light bulb assembly comprising:
a base to fit with a standard incandescent light fixture;
a center post located along an axis of the base;
a light emitting diode electrically connected to the base and electrically connected to the center post.

2. The light bulb assembly of claim 1, wherein a non-conductive filler is located within the base to electrically isolate the base from the center post.

3. The light bulb assembly of claim 1, wherein said light emitting diode is bonded to the base by a non-conductive material.

4. The light bulb assembly of claim 1, wherein said base is shaped to be received within a flashlight socket.

5. The light bulb assembly of claim 1, wherein said base is shaped to be received within a night light socket.

6. The light bulb assembly of claim 1, wherein said base is shaped to be received within an automotive instrument panel socket.

7. The light bulb assembly of claim 1, wherein at least one control is electrically connected to said light emitting diode to modify the output of the light emitting diode.

8. The light bulb assembly of claim 7, wherein said at least one control is located within the base.

9. The light bulb assembly of claim 7, wherein said at least one control selectively modifies the light emitting diode for use with both a DC current and an AC current.

10. The light bulb assembly of claim 1, wherein said light emitting diode includes a light emitting diode housing, and said housing has a modification to alter a nature of an emitted light.

11. The light bulb assembly of claim 10, wherein said housing modification is one of an internal shield or external shield bonded to the housing.

12. The light bulb assembly of claim 10, wherein said housing modification is translucent.

13. A light bulb assembly comprising:
a screw base having a screw thread and electrically connected to a light emitting diode wherein the light emitting diode can be selectively modified for use with both a DC current and an AC current.

14. The light bulb assembly of claim 13, wherein a center post is located along an axis of said screw base and said light emitting diode being electrically connected to said screw base and electrically connected to said center post.

15. The light bulb assembly of claim 14, wherein a non-conductive filler is located within the screw base to electrically isolate the screw base from the center post.

16. The light bulb assembly of claim 13, wherein said light emitting diode is bonded to the screw base by a non-conductive material.

17. The light bulb assembly of claim 13, wherein at least one control is electrically connected to said light emitting diode to modify the output of the light emitting diode.

18. (canceled)

19. A method manufacturing a light bulb comprising:
a) providing a base for a standard incandescent light fixture;
b) connecting a light emitting diode to the base.

20. The method of claim 19, wherein said step b) includes providing a center post electrically isolated from the base and electrically connecting the center post to the light emitting diode.

21. The method of claim 19, further includes:
c) connecting a control to the light emitting diode for modifying the output of the light emitting diode.

22. The method of claim 21, wherein said step c) further includes modifying an intensity of the light emitting diode with the control.

23. The method of claim 21, wherein said step c) further includes modifying an output color of the light emitting diode with the control.

24. The method of claim 21, further including selectively modifying the light emitting diode for use with both a DC current and an AC current with the control.

25. The light bulb assembly of claim 10, wherein said modification alters a dispersion of the emitted light.
